(19) United States
(12) Patent Application Publication
(10) Pub. No.: US 2009/0251894 A1
(43) Pub. Date: Oct. 8, 2009

(54) LED flexible rod light device and process for manufacturing same

(76) Inventor: Nei Cheng Tsai, Zhonghe City (TW)

Correspondence Address: TROXELL LAW OFFICE PLLC, SUITE 1404, 5205 LEESBURG PIKE, FALLS CHURCH, VA, 22041, US

(21) Appl. No.: 12/078,746

(22) Filed: Apr. 4, 2008

(51) Int. Cl. F21S 4/00; H01J 9/00

(52) U.S. Cl. 362/219; 445/23

(57) ABSTRACT

LED flexible rod light device and process for manufacturing the same are disclosed. The LED flexible rod light device is flexible and comprises a positive wire and a negative wire being parallel to each other; a plurality of bare LED chips each connected to the positive wire and the negative wire via leads; and a packagine material for enclosing the positive wire, the negative wire, and the bare LED chips.

### BACKGROUND OF THE INVENTION

1. Field of Invention

The invention relates to LED (light-emitting diode) flexible rod light devices and more particularly to LED flexible rod light devices having an LED light array with reduced diameter and other advantageous features and a process for manufacturing the same.

2. Description of Related Art

A conventional LED lamp is shown in FIG. 1. The LED lamp comprises a positive pin 11 having a positive terminal 111, a negative pin 12 having a negative terminal 121, an LED chip 10 (normally refer to bare LED chip) mounted on the negative pin 12, an interconnecting lead 13 interconnected the positive pin 11 and the LED chip 10, and a packaging material (e.g., epoxy resin, polycarbonate, polyethylene terephthalate, polyethylene nephthalate, polyimid, and polyacrylate) 14 formed around the above components with only the positive terminal 111 and the negative terminal 121 extending beyond to electrically connect to a socket (not shown) which is in turn electrically connected to a positive wire (not shown) and a negative wire (not shown), respectively.

A conventional LED flexible rod light device 100 incorporating a plurality of LED units (not numbered) arranged as an array is shown in FIG. 2. The positive terminal 111 and the negative terminal 121 of each LED unit extend to electrically connect to a positive wire 15 and a negative wire 16, respectively. The LED units are each constructed the same as the LED lamp shown in FIG. 1. The LED flexible rod light device 100 is enclosed by a packaging material (not numbered).

The LED flexible rod light device 100 is disadvantageous due to the following reasons. The positive terminal 111 and the negative terminal 121 of each LED unit are connected to the positive wire 15 and the negative wire 16 by a time consuming soldering process respectively. Hence, both its production and yield are low. Diameter θ1 of the LED flexible rod light device 100 is relatively large because a plurality of LED units each including pins 11, 12, an LED chip 10, an interconnecting lead 13, and a packaging material 14 are formed in the LED flexible rod light device 100. As a result, applications of the LED flexible rod light device 100 are limited.

Thus, continuing improvements in the exploitation of LED flexible rod light device and process for manufacturing same without the above drawbacks are constantly being sought.

### SUMMARY OF THE INVENTION

It is therefore one object of the invention to provide a process for manufacturing an LED flexible rod light device comprising the steps of: placing a positive wire and a negative wire at predetermined positions in a mold, respectively; placing each of a plurality of bare LED chips at a predetermined position in the mold; interconnecting each bare LED chips to the positive wire and the negative wire via leads; injecting molten packaging material onto the mold including the positive and the negative wires and the bare LED chips to enclose the positive and the negative wires and the bare LED chips; and curing the packaging material to produce the LED flexible rod light device.

It is another object of the invention to provide an LED flexible rod light device comprising at least one positive wire and at least one negative wire being parallel thereto; a plurality of bare LED chips each connected to the positive wire and the negative wire via leads; and a packaging material for enclosing the positive wire, the negative wire, and the bare LED chips.

In the LED flexible rod light device, the packaging material can be any material which is transparent and flexible after curing, such as thermoset resin or thermoplastic resin, for example, epoxy resin, polycarbonate, polyethylene terephthalate, polyethylene naphthalate, polyimide, and polyacrylate, and the like).

In the LED flexible rod light device, the positive and the negative wires can be further coated with an insulating material except where the bare LED chip is to be mounted.

The above and other objects, features and advantages of the invention will become apparent from the following detailed description taken with the accompanying drawings.

### BRIEF DESCRIPTION OF THE DRAWINGS

FIG. 1 is a longitudinal sectional view of a conventional LED lamp;

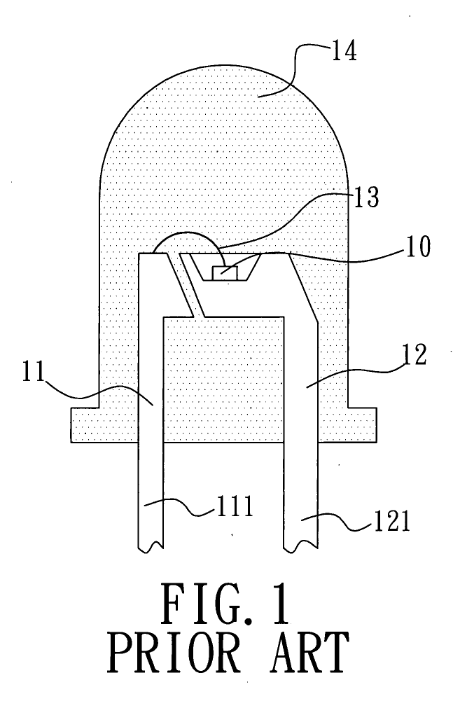

FIG. 2 is a schematic longitudinal sectional view of a portion of conventional LED flexible rod light device having an LED light array;

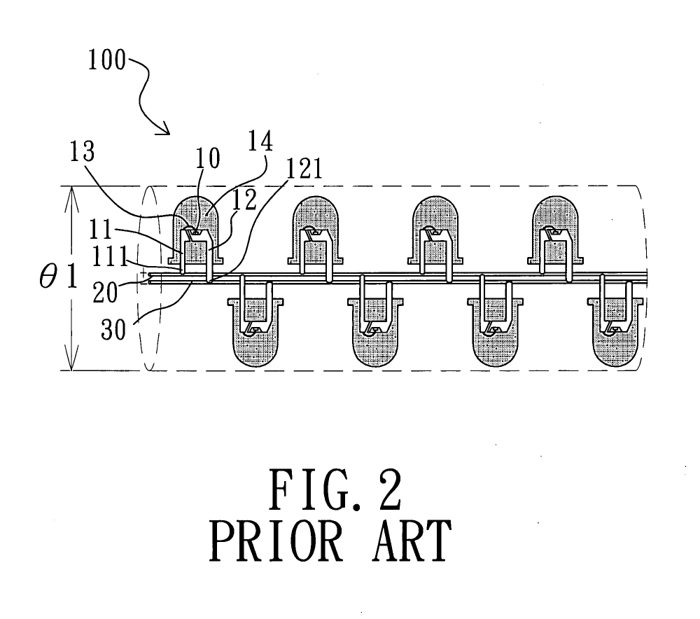

FIG. 3 is a flowchart depicting a process for manufacturing LED flexible rod light device according to the invention;

FIG. 4 is a schematic longitudinal sectional view of a portion of a first configuration of a first preferred embodiment of LED flexible rod light device according to the invention wherein the LED is a red or yellow LED;

FIG. 5 is a sectional view taken along line A-A of FIG. 4;

FIG. 6 is a schematic longitudinal sectional view of a portion of a second configuration of the first preferred embodiment of LED flexible rod light device according to the invention wherein the LED is a blue or green LED;

FIG. 7 is a sectional view taken along line A-A of FIG. 6;

FIG. 8 is a schematic longitudinal sectional view of a portion of a first configuration of a second preferred embodiment of LED flexible rod light device according to the invention wherein a second positive wire and a second negative wire are incorporated, and a plurality of groups having sequentially arranged red LED, blue LED, yellow LED, and green LED are provided along the wires;

FIG. 9 is a schematic longitudinal sectional view of a portion of a second configuration of the second preferred embodiment of LED flexible rod light device according to the invention wherein a switch is additionally provided between a power source and the positive wires and the switch is switched to connect the first positive wire, and a plurality of groups having sequentially arranged yellow LED and red LED are provided along the wires;

FIG. 10 is a schematic longitudinal sectional view of a portion of a third configuration of the second preferred embodiment of LED flexible rod light device according to the invention wherein a switch is additionally provided between a power source and the positive wires and the switch is switched to connect the second positive wire, and a plurality of groups having sequentially arranged yellow LED and red LED are provided along the wires;

FIG. 11 is a schematic longitudinal sectional view of a portion of a fourth configuration of the second preferred embodiment of LED flexible rod light device according to the invention wherein a switch is additionally interconnected the first positive wire and the second positive wire, and a plurality of groups having sequentially arranged yellow LED and red LED are provided along the wires;

FIG. 12 is a schematic longitudinal sectional view of a portion of a fifth configuration of the second preferred embodiment of LED flexible rod light device according to the invention wherein a switch is additionally interconnected two separate portions of the positive wire, and a plurality of groups having sequentially arranged yellow LED and red LED are provided along the wires;

FIG. 13 is a schematic longitudinal sectional view of a portion of a third preferred embodiment of LED flexible rod light device according to the invention; and

FIG. 14 is a sectional view taken along line B-B of FIG. 13.

### DETAILED DESCRIPTION OF THE INVENTION

LED flexible rod light device of the present invention can be implemented as an LED flexible rod light device of any color. The LED chip described herein is referred to a red, yellow, blue and/or green LED chips.

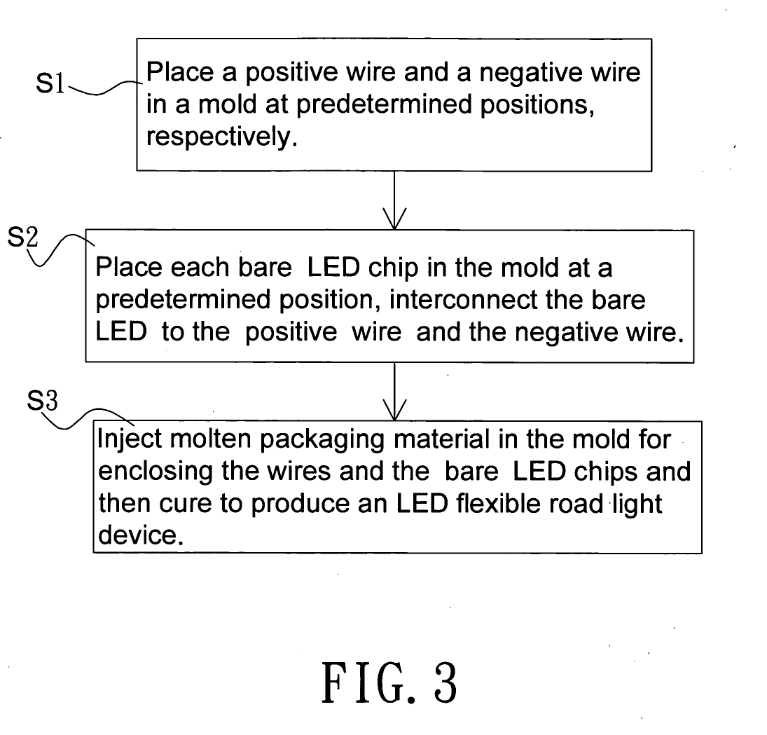

Referring to FIG. 3, a process for manufacturing LED flexible rod light device in accordance with the invention is illustrated. The process comprises the following steps.

In step S1, a positive wire and a negative wire are placed in respective grooves of a mold in which the positive wire is adapted to connect to a positive terminal of a power source and the negative wire is adapted to connect to a negative terminal thereof.

In step S2, each of a plurality of bare LED chips is placed at a predetermined position in the mold and the bare LED chip is connected to the positive wire and the negative wire via leads.

In step S3, molten packaging material (e.g., thermoset resin or thermoplastic resin, for example, epoxy resin, polycarbonate, polyethylene terephthalate, polyethylene naphthalate, polyimide, and polyacrylate, and the like) is injected onto the above components including positive and negative wires and bare LED chips for enclosing the same and after curing only a positive terminal of the positive wire and a negative terminal of the negative wire are exposed to be adapted to electrically connect to positive and negative terminals of a power source, respectively.

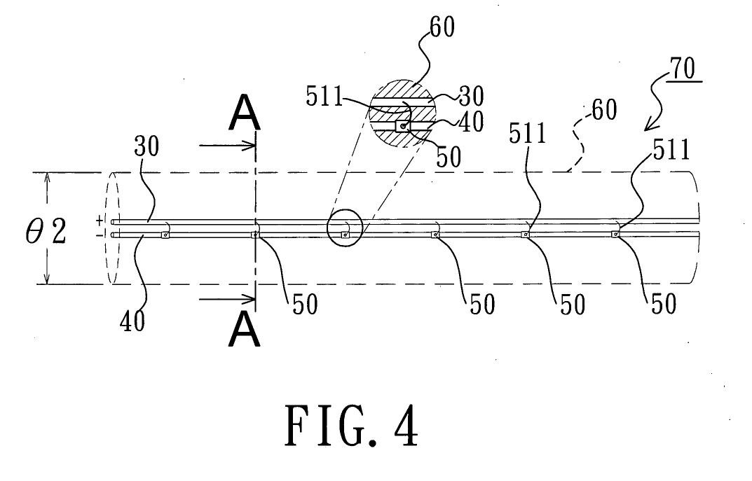

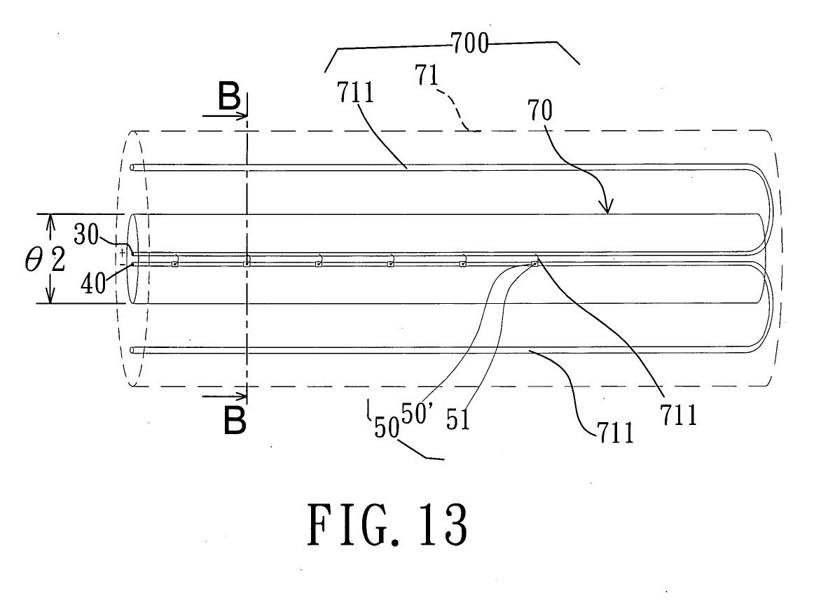

According to the present process, by directly mounting a bare LED chip in the present flexible rod light device, the diameter θ2 (see FIGS. 4 and 13) of the cylindrical LED flexible rod light device is relatively small.

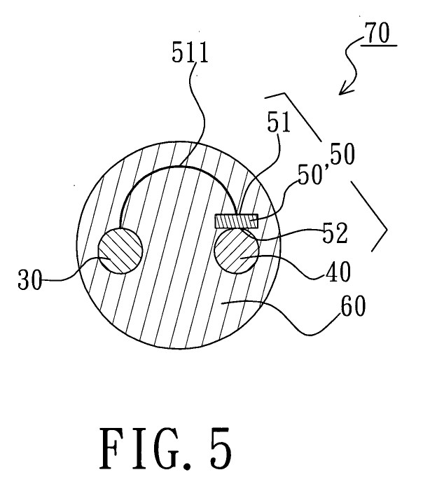

Referring to FIGS. 4 to 7, a first preferred embodiment of LED flexible rod light device according to the invention is shown. In FIGS. 4 and 5, a first configuration of a first preferred embodiment of LED flexible rod light device according to the invention is shown. The LED flexible rod light device 70 is shaped as a cylinder and comprises a positive wire 30, a negative wire 40, a plurality of equally spaced bare LED chips 50 arranged as a light array, and a packaging material 60 for enclosing the wires 30, 40 and the LED chips 50 with only a positive terminal of the positive wire 30 and a negative terminal of the negative wire 40 being exposed to be adapted to electrically connect to positive and negative terminals of a power source respectively as detailed later.

The LED chip 50 is a red or yellow LED chip 50′ and its positive electrode 51 is located on the top and its negative electrode 52 is located on the bottom. The negative electrode 52 is directly electrically connected to the negative wire 40. Further, an interconnecting lead 511 is electrically interconnected the positive wire 30 and the positive electrode 51.

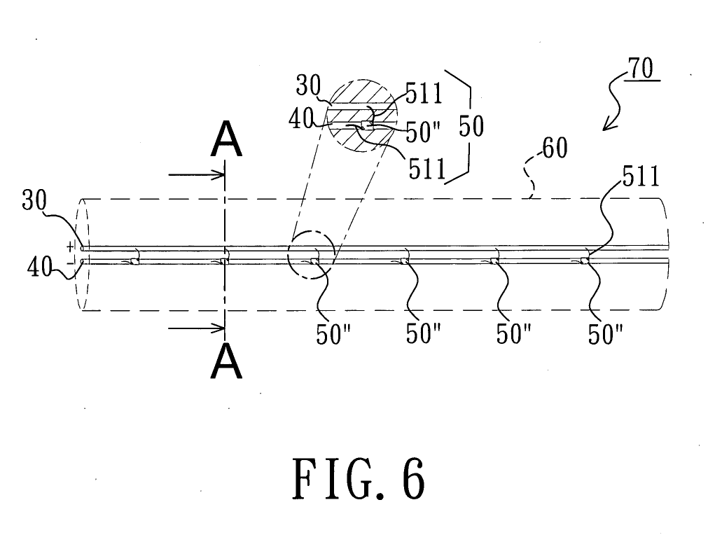

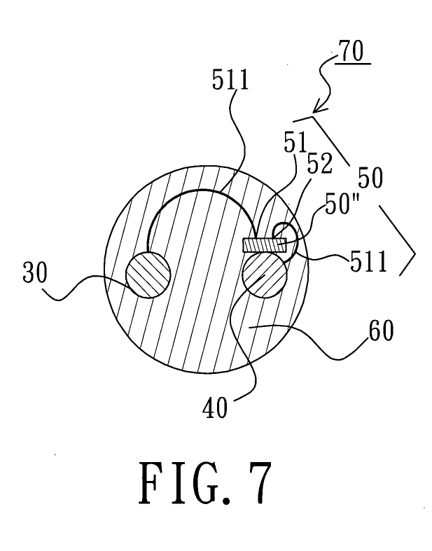

In FIGS. 6 and 7, a second configuration of the first preferred embodiment of LED flexible rod light device according to the invention is shown. The LED flexible rod light device 70 is shaped as a cylinder and comprises a positive wire 30, a negative wire 40, a plurality of equally spaced bare LED chips 50″ arranged as a light array, and a packaging material 60 for enclosing the wires 30, 40 and the LED chips 50″ with only a positive terminal of the positive wire 30 and a negative terminal of the negative wire 40 being exposed to be adapted to electrically connect to positive and negative terminals of a power source respectively as detailed later.

The LED chip 50 is a blue or green LED chip 50″ and its positive electrode 51 and its negative electrode 52 are both located on the top. Further, a first interconnecting lead 511 is electrically interconnected the positive wire 30 and the positive electrode 51 and a second interconnecting lead 511 is electrically interconnected the negative wire 40 and the negative electrode 52, respectively.

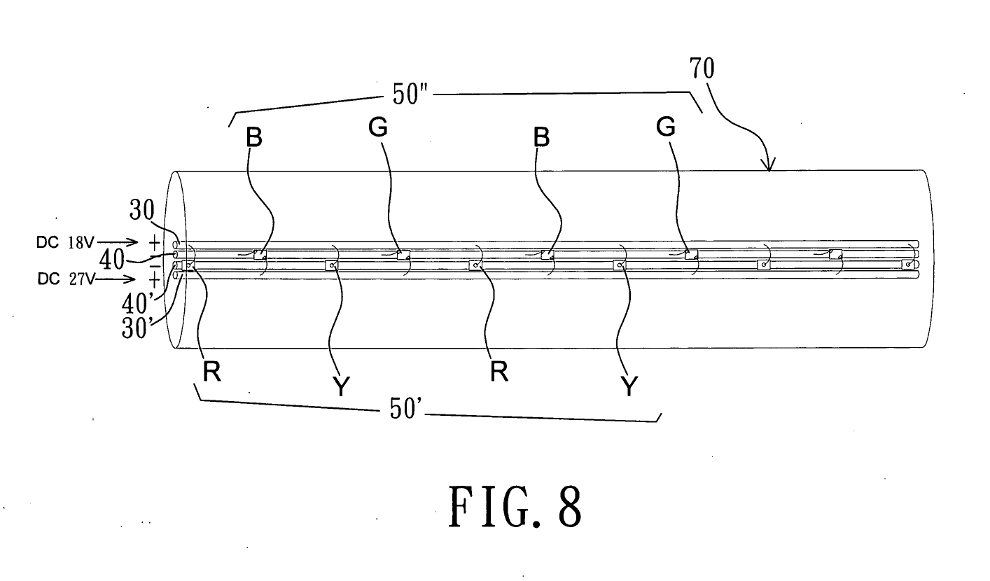

Referring to FIGS. 8 to 12, a second preferred embodiment of LED flexible rod light device according to the invention is shown. In a first configuration of the second preferred embodiment (see FIG. 8), a second positive wire 30′ and a second negative wire 40′ are included in a parallel relationship to the wires 30 and 40. Also, a plurality of groups having sequentially arranged red (R) LED chip 50′, blue (B) LED chip 50″, yellow (Y) LED chip 50′ and green (G) LED chip 50″ are provided in which the red LED chips 50′ are electrically interconnected the positive wire 30 and the second negative wire 40′, the yellow LED chips 50′ are electrically interconnected the positive wire 30 and the second negative wire 40′, the blue LED chips 50″ are electrically interconnected the second positive wire 30′ and the negative wire 40, and the green LED chips 50″ are electrically interconnected the second positive wire 30′ and the negative wire 40 respectively. DC 18V power is fed to an electric circuit comprising the positive wire 30 and second negative wire 40′ and DC 27V power is fed to an electric circuit comprising the second positive wire 30′ and negative wire 40, respectively. As a result, a colorful LED flexible rod light device is produced.

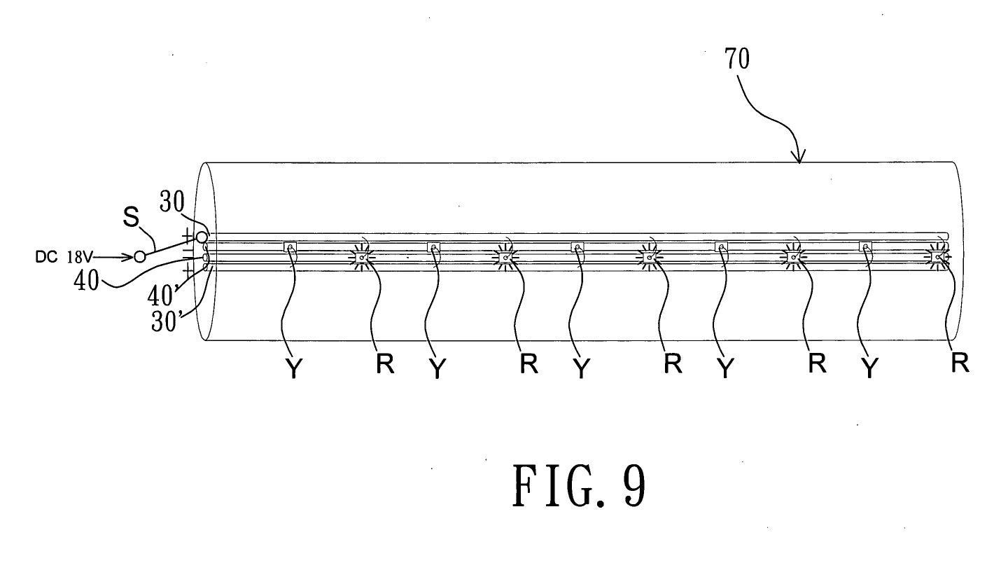

In a second configuration of the second preferred embodiment (see FIG. 9), a switch (e.g., toggle switch) (S) is additionally provided between the power source (DC 18V) and the first positive wire 30 or the second positive wire 30′ and the switch (S) is switched to connect the positive wire 30. Also, a plurality of groups having sequentially arranged yellow LED and red LED chips are provided in which the yellow LED chips are electrically interconnected the second positive wire 30′ and the second negative wire 40′ and the red LED chips are electrically interconnected the positive wire 30 and the negative wire 40 respectively. The red LED chips are lit when the switch (S) is switched to connect the first positive wire 30.

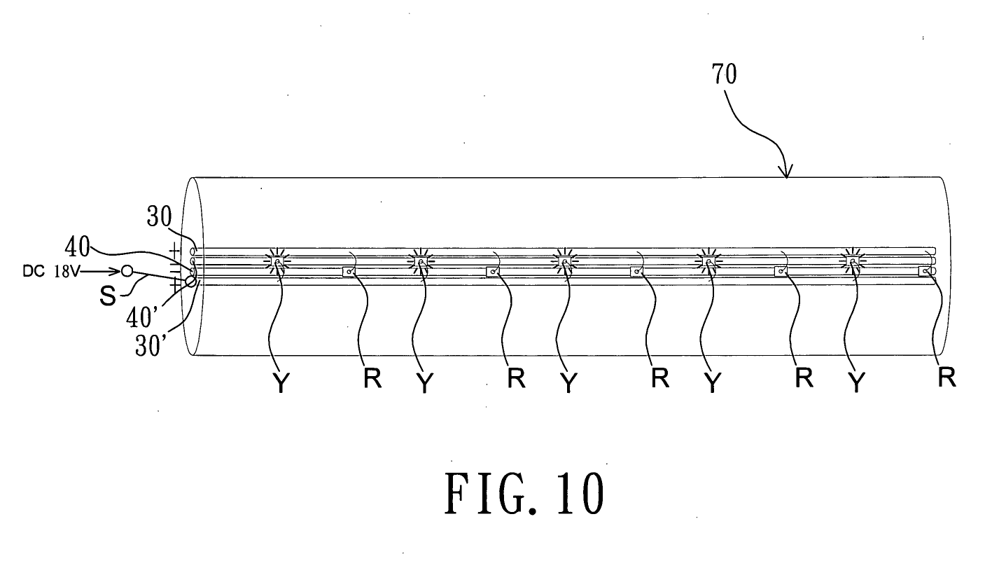

In a third configurations of the second preferred embodiment (see FIG. 10), the yellow LED chips are lit when the switch (S) is switched to connect the second positive wire 30′. By sequentially repeatedly carrying out the second and the third configurations of the second preferred embodiment (i.e., by repeatedly switching one end of the switch (S) between the positive wire 30 and the second positive wire 30′), a flashing effect is obtained.

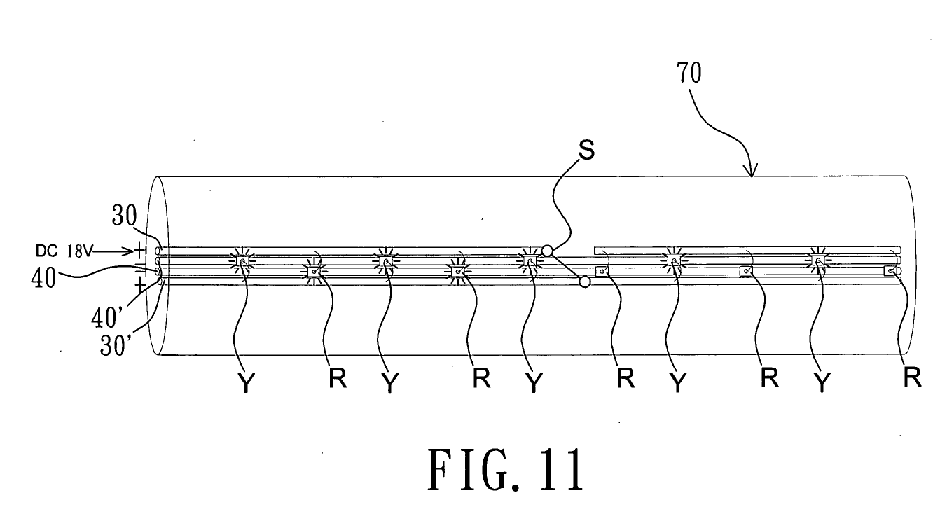

In a fourth configuration of the second preferred embodiment (see FIG. 11), a switch (S) is additionally provided between the positive wire 30 and the second positive wire 30′ and can be switched to connect the positive wire 30 to either another positive wire 30 or the second positive wire 30′. The yellow LED chips are lit when the switch (S) is switched to connect the positive wire 30 to the second positive wire 30′.

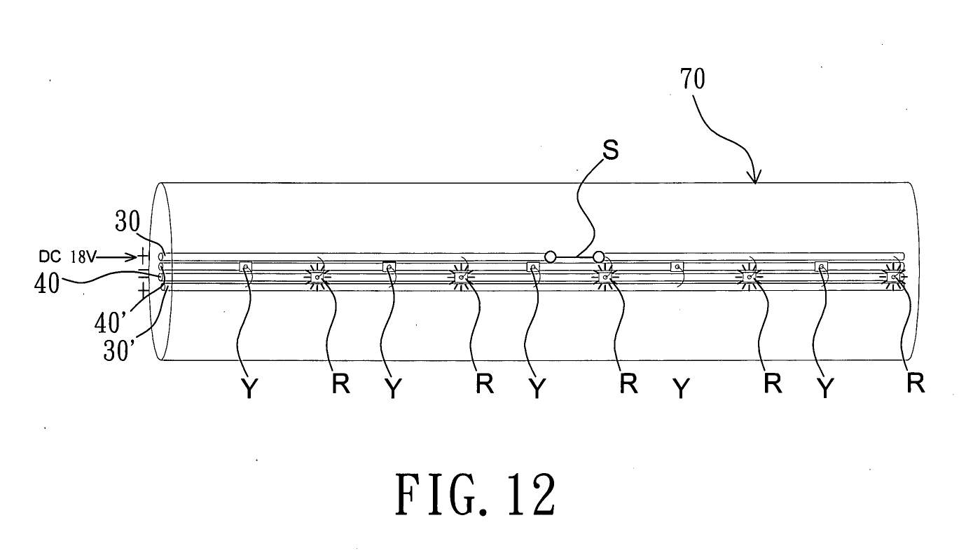

In a fifth configuration of the second preferred embodiment (see FIG. 12), the red LED chips are lit when the switch (S) is switched to connect the positive wire 30 and another positive wire 30. By sequentially repeatedly carrying out the fourth and the fifth configurations of the second preferred embodiment (i.e., by repeatedly switching one end of the switch (S) to connect the positive wire 30 to either another positive wire 30 or the second positive wire 30′), a flashing effect at the second half portion of the LED flexible rod light device is obtained.

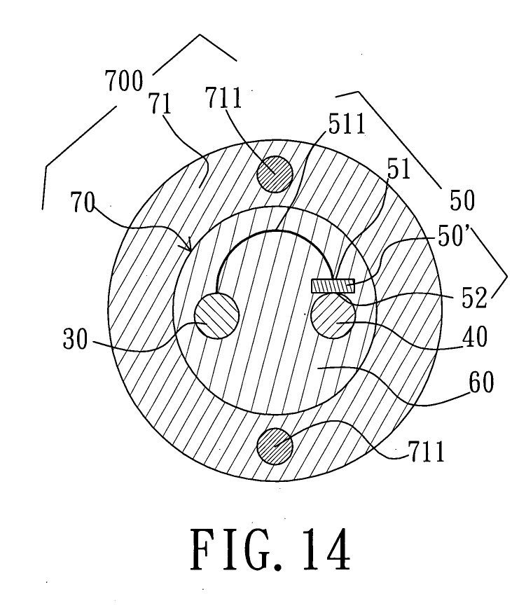

Referring to FIGS. 13 and 14, a third preferred embodiment of LED flexible rod light device according to the invention is shown. The third preferred embodiment substantially has same structure as the first preferred embodiment shown in FIG. 4, except that a PVC layer 71 is formed around the LED flexible rod light device 70 to form a larger LED flexible rod light device 700, two leads 711 formed of a conductive material (e.g., copper) are bent at and extended from the other ends of the positive wire 30 and negative wire 40 along the PVC layer 71 respectively (i.e., forming two U shapes), each LED chip 50 is a red or yellow LED chip 50′ and its positive electrode 51 is located on the top and its negative electrode 52 is located on the bottom, the negative electrode 52 is directly electrically connected to the negative wire 40, and an interconnecting lead 511 is electrically interconnected the positive wire 30 and the positive electrode 51.

The invention has the following advantages. The manufacturing process is fast by eliminating the time consuming soldering process. Hence, both its production and yield are high. Diameter θ2 (see FIGS. 4 and 13) of the cylindrical LED flexible rod light device is relatively small by eliminating some components (i.e., more compact). Hence, applications of the LED flexible rod light device are wide.

While the invention herein disclosed has been described by means of specific embodiments, numerous modifications and variations could be made thereto by those skilled in the art without departing from the scope and spirit of the invention set forth in the claims.

What is claimed is:

1. A process for manufacturing an LED (light-emitting diode) flexible rod light device comprising the steps of:
(i) placing positive wires and negative wires at predetermined positions in a mold, respectively;
(ii) placing each of a plurality of bare LED chips at a predetermined position in the mold;
(iii) interconnecting each bare LED chip to the positive wire and the negative wire;
(iv) injecting packaging material onto the mold to enclose the positive and negative wires and the bare LED chips; and
(vi) curing the packaging material to produce the LED flexible rod light device with a positive terminal of the positive wire and a negative terminal of the negative wire being exposed.

2. The process of claim 1, wherein the positive and the negative wires are further coated with an insulating material except the positions to be connected with terminals of the LED chips.

3. An LED (light-emitting diode) flexible rod light device comprising:
at least one positive wire and at least one negative wire being parallel to each other;
a plurality of bare LED chips connected to the positive wire and the negative wire via leads; and
a packaging material for enclosing the positive wire, the negative wire, and the bare LED chips into a flexible rod light device.

4. The LED flexible rod light device of claim 3, wherein the positive and the negative wires are further coated with an insulating material except the positions to be connected with terminals of the LED chips.

5. The LED flexible rod light device of claim 3, wherein the bare LED chips are selected from the group consisting of bare red LED chips, bare blue LED chips, bare yellow LED chips, and bare green LED chips.

6. The LED flexible rod light device of claim 3, which comprises at least two positive wires and at least two wires.

7. The LED flexible rod light device of claim 3, which further comprises a switch provided between the positives wire and a power source and for switching between the positive wires.

8. The LED flexible rod light device of claim 6, further comprising a switch provided between the positive wires and for switching between them.
